(19) United States
(12) Patent Application Publication
(10) Pub. No.: US 2021/0206615 A1
(43) Pub. Date: Jul. 8, 2021

(54) MIXING NOZZLE FITMENT

(71) Applicants: Balakrishna REDDY, Dublin, OH (US); NESTEC S.A., Vevey (CH)

(72) Inventors: Balakrishna Reddy, Dublin, OH (US); Jonathan Mastny, Dublin, OH (US); Joshua Headings, Plain City, OH (US); Robart Mora, Worthington, OH (US)

(21) Appl. No.: 16/065,379

(22) PCT Filed: Dec. 28, 2015
(86) PCT No.: PCT/US2015/067641

§ 371 Date: Jun. 22, 2018

(51) Int. Cl. B67D 1/00

(52) U.S. Cl. CPC B67D 1/0044; B67D 1/10; B67D 1/0079; B67D 1/0021

(57) ABSTRACT

The invention concerns a mixing nozzle fitment for mixing a concentrate and a diluent, for dispensing the mixture and for fitting in a beverage preparation machine comprising: —a first shaft (10) defining a diluent inlet passage (11), and —a second shaft (20) defining a curved diluent passage (21) and attached to an end of the first shaft, and —a third shaft (30) attached to the second shaft, the third shaft defining a concentrate passage that leads into the curved diluent passage of the second shaft, and —a squeezable valve (40) positioned through the third shaft.

### FIELD OF THE INVENTION

The present invention relates to a mixing nozzle configured for being introduced in beverage dispensing machines and designed for mixing a concentrate with a diluent in order to prepare a beverage.

### BACKGROUND OF THE INVENTION

There are a variety of beverage dispensers currently on the market. Some beverage dispensers operate by dispensing a hot or cold ready-to-drink fluid directly into a container such as a cup. Other beverage dispensers operate by dispensing a powdered or liquid concentrate along with a separate diluent through a beverage dispensing nozzle and into a container or cup to form the drink.

The present invention relates to post-mix dispensers in which a liquid concentrate is stored and is automatically combined at the time of dispensing with a diluents such as water at a predetermined ratio. The combination is usually operated in a mixing chamber in which the concentrate and the diluents emerge. The relative flows of the concentrate and diluent can be controlled to maximize the qualities of the beverage such as mixing and foam production. This mixing chamber can be a mixing tee fitment such as described in WO 01/21292 and U.S. Pat. No. 7,111,759. In these prior arts the mixing tee fitment comprises a horizontal diluent inlet portion joined to vertical beverage outlet portion by an elbow and a vertical concentrate inlet emerging in the horizontal diluent inlet portion.

It has been observed that the above type of fitment could lead to accumulation of concentrate in dead zones. This accumulation can lead to hygienic problems if the beverage concentrates are sensible to bacteria such as milk. This problem is emphasized if the dispenser is intermittently used. In addition the concentrate could also get into the water inlet stream and create problems from a hygienic point of view, especially since the water inlet valve is part of the machine and not easily cleanable.

WO 2010/115888 has proposed a solution to these problems and define a mixing nozzle fitment with a horn shape that guarantees that concentrate does no accumulate in the mixing nozzle and that water efficiently rinses the mixing nozzle.

The above fitments are usually connected to a concentrate package through a valve consisting of the flexible tube surrounding a coupling member. Concentrate pumped from the container exerts a pressure on the flexible tube, so that the tube expands around the coupling member and concentrate flows through the passage created around the coupling member.

Several issues have been observed with current existing fitments.

First the dosing accuracy is not optimal and frequently some inconsistencies in concentrate dosing have been observed. Consequently the taste of produced beverages is not constantly the same.

Secondly, the valve in the fitment of the state of the art is not convenient for dispensing concentrates comprising seeds or pulp. Actually pulp and seeds remain blocked between the tube and the coupling member and present the valve from closing.

An object of the invention is to address at least some of the drawbacks of the prior art.

### SUMMARY OF THE INVENTION

In a first aspect of the invention, there is provided a mixing nozzle fitment for mixing a concentrate and a diluent, for dispensing the mixture and for fitting in a beverage preparation machine comprising:
a first shaft defining a diluent inlet passage, and
a second shaft defining a curved passage and attached to an end of the first shaft, and
a third shaft attached to the second shaft, the third shaft defining a concentrate passage that leads into the curved passage of the second shaft, and
a squeezable valve positioned through the third shaft said squeezable valve being dome shaped, the top of the dome being oriented in direction of the second shaft, and the top of the dome comprising a slit.

The mixing nozzle fitment is configured for being connected to a concentrate supply and a diluent supply and to mix the diluent and the concentrate.

The mixing nozzle fitment is also configured for dispensing the mixture resulting from the mixing of the diluent and the concentrate.

The mixing nozzle fitment is also configured for fitting in a beverage preparation machine.

The fitting in the machine enables the connection of the mixing nozzle fitment to the concentrate supply and the diluent supply and the dispensing of the resulting mixture to a dispensing area of the machine.

This type of mixing nozzle fitment and machine is described in WO 2010/115888.

The mixing nozzle fitment includes a first shaft defining a diluent inlet passage.

The mixing nozzle fitment includes a second shaft defining a curved outlet passage and attached to one end of the first shaft.

The second shaft can present the shape of a curved horn.

Preferably the second shaft is almost perpendicular to the first shaft near its end portion of the second shaft opposed to the attachment with the first shaft. Accordingly when the mixing nozzle fitment is attached to a beverage preparation machine, the first shaft can be essentially horizontally oriented and attached by an end to a diluent supply and the end portion of the second shaft opposed to the attachment with the first shaft can be essentially vertically oriented in order to dispense the mixture of diluent and concentrate.

The mixing nozzle fitment includes a third shaft attached to the second shaft. The third shaft defines a concentrate inlet passage that leads into the curved passage of the second shaft.

Generally the third shaft is straight.

Generally the third shaft is attached to the external part of the curved passage.

Preferably the third shaft is positioned relatively to the second shaft so that the longitudinal axis of the third shaft extends through the internal part of the second shaft. The longitudinal axis of the third shaft intersects the second shaft but not the first shaft. Consequently there is no risk that concentrate lands on the first shaft and becomes hardly dissolve.

The mixing nozzle fitment comprises a squeezable valve positioned through the third shaft. This squeezable valve is dome shaped, the top of the dome being oriented in direction of the second shaft and the top of the dome comprises a slit.

When a certain pressure is exerted on the valve, the edges of the slit move away. Accordingly an opening is created.

Preferably the top of the dome of the valve comprises a flat area.

The slit at the top of the dome can present different designs depending on the nature of the concentrate to be dispensed and on the aspect desired for the final beverage (essentially dispensing a foamed or a flat beverage).

Preferably the slit presents the shape of a straight line, a cross or a Y. Depending on the shape of the slit, different types of mixing can occur and different types of beverages can be prepared. A Y slit enables the production of a flat beverage devoid of foam. A straight line slit enables the production of a foamed beverage.

Preferably the squeezable valve is made of silicon or elastomer material.

Preferably the silicon or elastomer material of the valve presents such a Shore hardness that its durometer is of at least 50 Shore “A”, preferably of about 70 Shore “A” measured on ASTM D2240 type A durometer, values of durometer being given a with a +/−10% precision.

Preferably the squeezable valve is able to withstand an opening pressure comprised between 0.25 and 0.5 psi.

Preferably the valve is designed for being able to sit on the edge of a first end of the third shaft. The dome of the valve can be surrounded by a circular lip designed for leaning on the edge of the first end of the third shaft.

The top of the valve can comprise a raised ring configured for acting as an O ring with an upstream connector, such as a cover described hereunder. This ring prevents leaks and ingress of any foreign materials.

Preferably the fitment comprises a cover for locking the squeezable valve in the third shaft and for enabling the coupling of the third shaft with a tube in order to deliver concentrate to the third shaft. This cover can be designed for snap fitting with the first end of the third shaft and simultaneously pressing a part of the valve against the edge of said first end of the third shaft. The cover can comprise a hollow cylinder configured for being attached to a tube for dispensing concentrate.

Generally all the shafts includes an essentially cylindrical shape.

Preferably the first shaft includes;
a first end at its inlet, and
a second end attached to the second shaft, and the first end has a section that is smaller than the section of the second end.

Preferably, the second shaft includes:
a first end attached to the first shaft, and
a second end at its outlet, and the first end has a section that is smaller than the section of the second end.

Preferably the first and the third shafts are perpendicular.

Preferably the first, the second and the third shafts are made one single piece of material.

A flexible tube can be attached to the third shaft. The flexible tube is designed for cooperating with an external peristaltic pump. A piercing fitment can be included at the end of the flexible tube opposed to the third shaft. That piercing fitment is designed for fitting in a beverage concentrate container like a bag-in-box.

In a second aspect, the present disclosure provides a package comprising a concentrate container and a mixing nozzle fitment with a flexible tube such as described above, wherein the container is in fluid communication with the flexible tube of the mixing nozzle fitment. The container can be a flexible storing pouch, preferably hold in a box. This type of container is usually known as a bag-in-box.

The container preferably comprises multiple portions of a beverage concentrate.

The concentrate can comprise pulp, particles and/or seeds. Preferably the particles and/or seeds present a size of at most 5 mm.

The beverage concentrate can be selected in the list of orange or grapefruit juice with pulp, fruit juices or purees comprising seed like pomegranate, strawberry puree, raspberry puree. The package is usually disposable.

In a third aspect, the present disclosure provides a beverage preparation machine comprising:
a mixing nozzle fitment as defined above positioned inside the dispensing device so that:
   the first shaft is horizontal, and
   the second shaft is almost vertical near its end portion opposed to the attachment with the first shaft, and
   the third shaft is vertical, and
a concentrate container attached to the third shaft of the mixing nozzle by means of a flexible tube,
a diluent supply tube removably attached to the first shaft of the mixing nozzle fitment,
a pump operatively connected to the flexible tube.

The pump operatively connected to the flexible tube can be a peristaltic pump.

In an embodiment, the concentrate container, the tube, the pump, the diluent supply and a portion of the mixing nozzle fitment are contained within a housing.

The machine can encompass a refrigerated compartment in which at least the concentrate container is placed. Then the mixing nozzle fitment can comprise a flange on the second shaft so as to isolate the refrigerated compartment from the rest of the dispensing device. The flange helps in energy conservation and keeps the refrigerated cabinet in a cooler state. The concentrate container can be attached to the free end of the flexible tube of the mixing nozzle fitment by a piercing fitment.

In a fourth aspect, the present disclosure provides a method of making a beverage. The method comprises providing a beverage preparation machine as defined above and dispensing portions of concentrate through the mixing nozzle fitment of the package and a diluent through the diluent supply tube, the concentrate and the diluent being mixed in and dispensed out of the curved outlet passage of the mixing nozzle fitment to form the beverage.

Usually the diluent and the concentrate are delivered simultaneously.

In a preferred alternative, in a first step the diluent and the concentrate are delivered simultaneously, and in a second step, only diluent is delivered. During this second step diluent rinses the coupling member.

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### BRIEF DESCRIPTION OF THE DRAWINGS

The characteristics and advantages of the invention will be better understood in relation to the following figures

FIG. 1 is a perspective view of a mixing nozzle fitment according to the present invention,

FIG. 2 is a cross-sectional view of the fitment as taken along plane AA of FIG. 1,

FIG. 3 is a cross-sectional view of the first, the second and the third shafts,

FIG. 4 is a cross-sectional view of the valve 40,

FIG. 4a illustrates different shapes of slit in the valve,

FIGS. 5a and 5b are perspective and exploded views of the mixing nozzle fitment according to the present invention.

FIG. 6 is a perspective view of a beverage preparation machine.

### DETAILED DESCRIPTION OF THE DRAWINGS

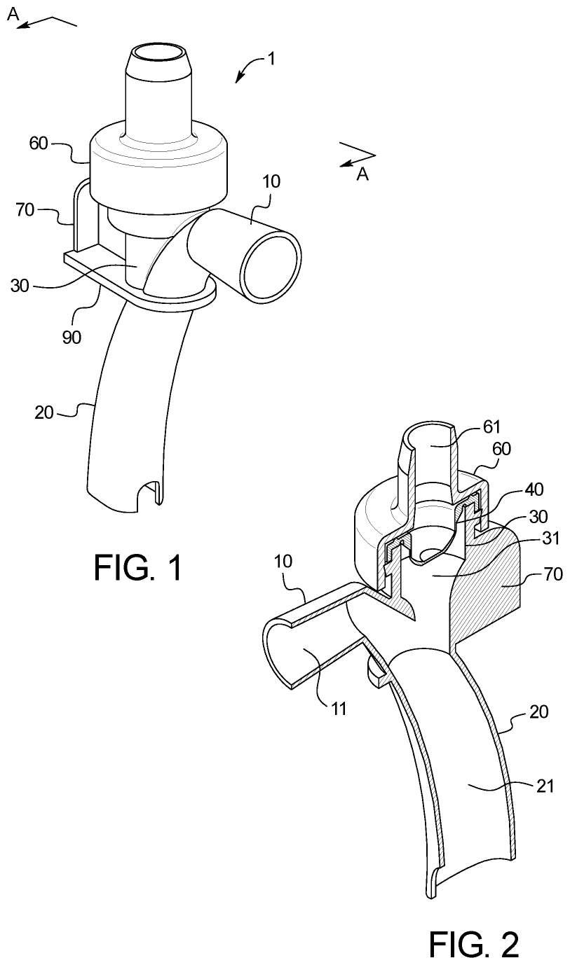

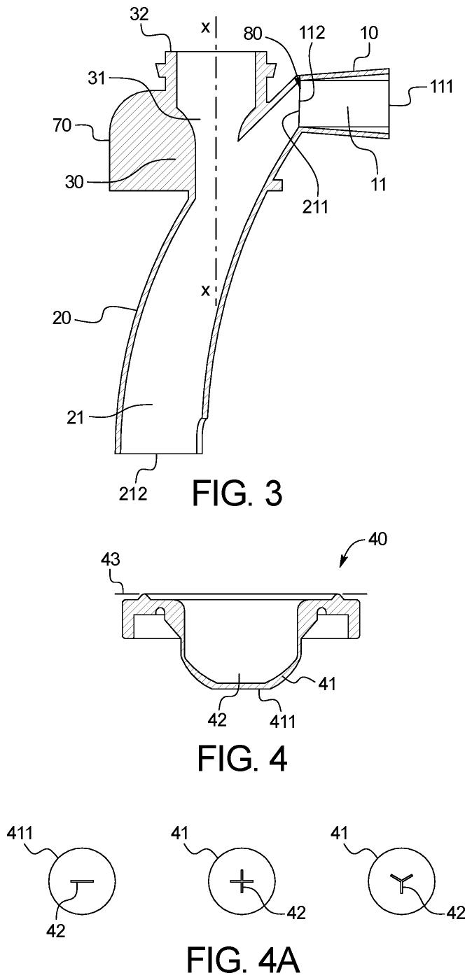

FIGS. 1, 2 and 3 illustrate a mixing nozzle fitment according to the invention. The mixing nozzle fitment 1 includes:
a first shaft 10 defining a first passage 11, and
a second shaft 20 defining a second curved passage 21 and attached to the first shaft 10, and
a third shaft 30 defining a third passage 31 and attached to the second shaft 20,
a squeezable valve 40 positioned through the third passage 31.

Second shaft 20 includes a handle 70.

First shaft 10 and third shaft 30 act as a fluid inlet and second shaft 20 acts as a fluid outlet. In the illustrated embodiment, first shaft 10 has a cylindrical shape with a first end 111 that has a larger width or diameter than a second end 112 of first shaft. Similarly, second shaft 20 has a cylindrical shape having an oval or elliptical cross-section with a second end 212 that has a larger width or diameter than a first end 211 of second shaft. Second end 112 of first shaft is attached to second end first 211 of second shaft at joint 80.

The dimensions of mixing nozzle fitment 1 can be any suitable size. For example, a key diameter for mixing nozzle fitment can be based on the interface of a water valve it has to mate with. Other dimensions of mixing nozzle fitment can be based on manufacturing ease.

The present disclosure relates to mixing nozzle fitments and beverage preparation machines using the mixing nozzle fitments. In alternative embodiments, the present disclosure can provide low cost and disposable mixing nozzle fitments for hygienic mixing and delivery of beverage products from concentrates in a beverage dispensing system. The mixing nozzle fitments can be used to mix and dispense a diluent such as water and a beverage concentrate while avoiding dead zones in the mixing nozzle fitments where the beverage concentrate can accumulate. Because the mixing nozzle fitment can be disposed of when a depleted bag of concentrate is thrown away, the need for a dispensing system having an electrically operated mixing bowl or mixing chamber that requires specific cleaning-in-place or cleaning after disassembly can be eliminated.

In another embodiment, second shaft 20 can be designed to incorporate one or more fins or baffles (not shown) along its inner walls at an angle to enable better mixing of the concentrate.

In yet another embodiment, second shaft 20 may be designed to incorporate a circuitous path (e.g. passage) such that the concentrate and diluent is mixed well by going through a circular path with a downward gradient through second shaft 20.

First shaft 10 and/or second shaft 20 can include various suitable perimeter or cross-sectional shapes such as, for example, polygonal, ellipsoidal, square, oval, triangular, etc. In an alternative embodiment, the opposing ends of first shaft 10 and second shaft 20 can have the same width or diameter.

First shaft 10 is constructed and arranged to be removably attached to any suitable diluent dispensing nozzle or a bore of a diluent line from a dispensing device or machine. For example, first shaft 10 can surround an internal outlet of the diluent dispensing nozzle, which can be firmly fitted inside inlet passage 11 of first shaft. The diluent dispensing nozzle should form a tight seal with first shaft 10 to prevent any diluent from leaking at the connection point between first shaft 10 and the dispensing nozzle. As a result, the diluent will not accumulate (e.g. in a dead zone) in any part of inlet passage 11 of first shaft.

As illustrated second shaft 20 has a curved shape (e.g. continuously bending line, without angles) from first end 211 to second end 212, for example, in the form of a curved horn. In this regard, second shaft 20 defines a flow passage 21 that is also curved (e.g. continuously bending line, without angles) from first end 211 to second end 212. In addition, in an embodiment, second shaft 20 is designed so that the internal width or diameter of passage 21 steadily increases from first end to second end.

Third shaft 30 defines a passage 31 and is positioned downstream or below joint 80 between second end 112 of first shaft and first end 211 of second shaft. Passage 31 of third shaft leads into flow passage 21 of second shaft. In this manner, third shaft can act as a concentrate outlet for a concentrate to mix with a diluent inside the passage 21. Third shaft 30 is attached to the external part of the curved shape of the second shaft 20.

Third shaft 30 can be positioned anywhere along second shaft 20 for example, from second end 112 of first shaft to about half way down second shaft. Generally, the higher the inlet position of the concentrate inlet of third shaft, the better it is for mixing. Also, in an embodiment, the concentrate inlet should be positioned on the vertical portion of mixing nozzle fitment such that the concentrate does not land onto a horizontal portion of first shaft.

In the embodiment illustrated in FIG. 4, the squeezable valve 4 comprises a dome 41, this dome comprises a slit 42 at its top 411. The edges of the slit close the passage 31 the valve when no pressure is exerted on the dome. These edges move away and opens the passage 31 when pressure is exerted by a fluid circulating from the first end 32 of the third shaft to the second shaft. Preferably the top 411 of the dome is flat.

The valve comprise a lip 43 of which shape fits with the edge of the first end 32 of the third shaft so that the valve can lean on said edge. The valve comprises a raised ring 44 presenting the function an O ring.

As illustrated in FIG. 4a, the slit 42 on the top 411 of the dome can present different designs: it can be a line, a cross or a Y shape or any other shape with a functional benefit on the dispensing of the beverage concentrate or the preparation of the beverage.

As illustrated in FIGS. 1 and 2, the fitment comprises a cover 60 for maintaining the valve 40 in the passage 31 of the third shaft. Said cover is configured for snap fitting with the first end 32 of the third shaft and simultaneously pressing the lip 43 of the valve against the edge of said first end of the third shaft. The cover comprises a fitment 61, a tube, configured for establishing a fluid communication of the concentrate with the third shaft.

Preferably the valve is positioned in the third shaft so that when diluent emerges from the first shaft 10, diluent flushes the concentrate below the valve and such that the diluent does not come in direct contact with the valve.

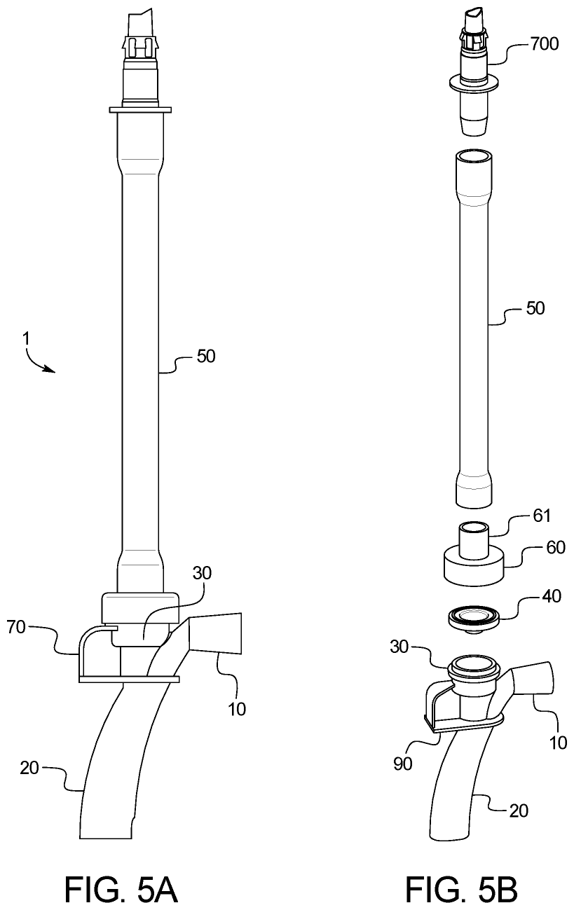

According to the embodiment of FIGS. 5a, 5b, a flexible tube 50 is attached at the first end of the third shaft by connection to the cover 60. For example, the open end of the tube can be stretched and placed over the tube 61 in the cover. The other end of the tube 50 be attached to a piercing fitment 100 designed to connect with a concentrate container.

The tube 50 usually is made of a flexible material so that it can be compressed by means of a pump device, which preferably is a peristaltic pump that is provided in a beverage preparation machine. The flexible material of the hose also allows it to resume its original shape after being compressed.

The valve 40 can be preferably operated in such way that it opens automatically when the pump device is operating and thereby increases the pressure in the tube and closes automatically when the pump device is disabled and the pressure thereby decreases in the tube. The pump device may be a peristaltic pump or a tube pump of another type that does not compress the tube when the tube is disabled.

In practice, this mixing nozzle fitment and the concentrate container can be provided to the operator either separated or fixed together. Generally the mixing nozzle fitment and the concentrate container are preferably separately provided to the operator. Then the operator connects the mixing nozzle fitment to the concentrate container only when the assembly of the mixing nozzle fitment and the container must be loaded in the dispenser. The piercing is usually made in a part of the container dedicated to and presenting an interface port adapted to receive the piercing fitment. Once the concentrate container is empty the whole assembly of the mixing nozzle fitment and the concentrate container is disposed.

The configuration of mixing nozzle fitment 10 solves the problem of product accumulation in dead zones within passage 32 of mixing nozzle fitment 10. For example, the curved horned shape of second shaft 30 and passage 32 (outlet end) of mixing nozzle fitment 10 is designed to minimize any beverage concentrate accumulation inside passage 32. In addition, by having concentrate outlet (passage 42) emerge in the diluent conduit (passage 32) downstream of joint 60, when the diluent flow enters in contact with the concentrate, the diluent presents a force sufficient to drag along the concentrate emerging from the concentrate outlet. As a result, no concentrate accumulation is observed in the mixing nozzle fitment 10, which maximizes the hygienicity of mixing nozzle fitment 10.

In alternative embodiments, the mixing nozzle fitment can include any suitable mechanism for attaching to the diluent dispensing nozzle or the diluent line of a dispensing device. For example, the mixing nozzle fitment can include a twist-to-lock feature (e.g. threading on the first shaft) to engage and lock the mixing nozzle fitment to the diluent dispensing nozzle or the diluent line of the dispensing device. Alternatively, the mixing nozzle fitment can include clamps or snap fits that engage with the diluent dispensing nozzle or the diluent line of the dispensing device to lock the mixing nozzle fitment in place.

Second shaft 20 can include a flange 90. Flange 90 can be used as the border when mixing nozzle fitment is used within a housing for a beverage preparation machine. For example, the housing containing a beverage device can be opened (e.g. through a front panel door) for receiving the mixing nozzle fitment. When the housing is closed, the only exposed portion of mixing nozzle fitment is a portion below flange 90.

Handle 70 can be any suitable shape that allows a user to securely hold mixing nozzle fitment. During use, handle 70 can be grasped by a user who is inserting mixing nozzle fitment into a beverage preparation machine. Handle 70 can also be grasped when removing mixing nozzle fitment from the machine.

In an embodiment, the three shafts 10, 20, 30 of the fitment can be in the form of a single unitary piece (e.g. molded). Alternatively, the mixing nozzle fitment can be made from a combination of separately made pieces that are attached together via process known in the art. It should be appreciated that the components of the mixing nozzle fitment can be made from any suitable material such as, for example, metal, rigid plastics or polymers or combinations thereof.

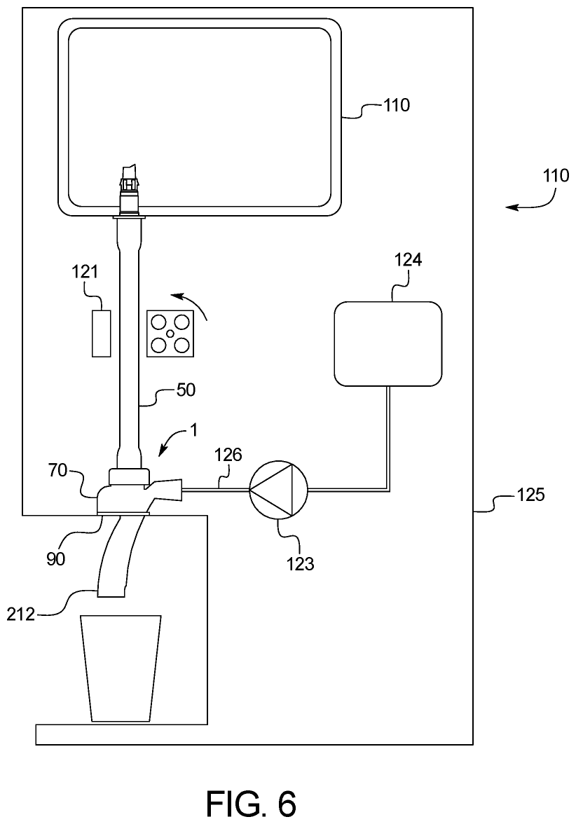

In another embodiment illustrated in FIG. 6, the present disclosure provides a beverage preparation machine 120 including a concentrate container 110, a tube 50 having a first end that is attached to an outlet of concentrate container and a pump 121 operatively connected to tube 50. Pump 121 can be, for example, a peristaltic pump that pushes concentrate from concentrate container 110 through tube 50 via a plurality of rotating rollers.

The machine 120 further includes a mixing nozzle fitment 1 in an embodiment similar to that shown in FIG. 1. The end portion of the tube 50 is removably attached to third shaft 30 of mixing nozzle fitment, for example, by being stretched and placed over retaining means 60. First shaft 10 of mixing nozzle fitment can be removably attached to a diluent supply line 126. Diluent supply line can be fluidly connected to any suitable diluent reservoir 124 and pump 123 for driving the diluent from the reservoir to mixing nozzle fitment. The machine can comprise devices for adjusting the temperature of the diluent like a heater or a cooler.

The mixing nozzle fitment 1 is positioned in the dispensing device so that the first shaft 10 attached to the diluent line is horizontal and the end portion 212 of the second shaft opposed to the attachment with the first shaft is almost vertical.

Concentrate container 110, tube 50, peristaltic pump 121, diluent supply line 126 and mixing nozzle fitment (or a portion thereof) can be contained within any suitable housing 125. As previously discussed, housing 125 containing the beverage device can be opened (e.g. through a front panel door) to receive removable mixing nozzle fitment. When housing is closed, for example, the exposed part of mixing nozzle fitment can be a portion below a flange of mixing nozzle fitment. Housing 125 can be constructed and arranged so that mixing nozzle fitment 1 dispenses the mixed concentrate and diluent directly into a cup or container 126. The housing 125 can also be a refrigerated compartment that isolates the concentrate container 110 from the ambient atmosphere to keep it cold. The flange can help in closing the passage at the bottom of the housing for introducing the mixing nozzle fitment and consequently in maintaining the refrigerated compartment isolated from ambient atmosphere and keeping it cold.

Mixing nozzle fitment 1 can seal tightly against diluent supply line 126 and be easily locked into place. Mixing nozzle fitment 1 permits a supply of hot or cold liquid such as water to dilute and mix with stable, packaged liquid concentrates, and dispense into cup 126. Mixing nozzle fitment 1 provides a way to keep the liquid concentrate from accumulating in any dead zones, which may create sanitary issues (e.g. microbial or quality issues) when the liquid concentrate resides there over time while the beverage dispenser is not in use.

In yet another embodiment, the present disclosure provides a method of making a beverage. The method comprises providing a dispensing device such as described above including
a mixing nozzle fitment such as described above positioned inside the beverage preparation machine so that the first shaft is horizontal and the second shaft is almost vertical near its end portion opposed to the attachment with the first shaft and the third shaft is essentially vertical,
a concentrate container attached to the end of the flexible tube, that is attached to the third shaft of the mixing nozzle fitment,
a diluent supply line removably attached to the first shaft of the mixing nozzle fitment
a pump operatively connected to the flexible tube.

A concentrate is dispensed through the concentrate tube, and a diluent is dispensed through the diluent dispenser nozzle. The concentrate and the diluent are mixed in and dispensed out of the curved outlet passage of the mixing nozzle fitment to form the beverage.

The diluent can be water.

The concentrate can be in a suitable form such as a paste, liquid or a combination thereof. The concentrate can have any suitable flavor or combination of flavors as well. The concentrate can even comprises particles, seeds, pulp. There is no risk that the particles remains blocked in the valve.

According to a first mode the method can comprise the preliminary steps of providing a mixing nozzle fitment as defined above and attaching the flexible tube to a concentrate container and the first shaft to the diluent dispenser nozzle.

According to a second mode the method can comprise the preliminary steps of providing a package as defined above and attaching the first shaft to the diluent dispenser nozzle.

The mixing nozzle fitment of the present invention can also be used as a simple dispensing nozzle without introducing diluent in the first shaft while dispensing the concentrate. Water may simply be introduced through the first shaft in order to rinse the second shaft after dispensing the concentrate.

The mixing nozzle fitment of the present invention improves the dosing accuracy of the concentrate compared to the fitment described in WO 2010/115888, even when concentrates comprise pulp and/or seeds.

In some tests, a whole bag-in-box was emptied by dosing successively portions of concentrate with a peristaltic pump as illustrated in FIG. 6. At each dosing the same rotation of the pump was applied. Each dosed portion of concentrate was weighed in order to evaluate the consistency of the successive dosing operations. The concentrate was orange concentrate comprising pulp. The standard deviation of doses with the mixing nozzle fitment of the present invention was smaller compared to the standard deviation of doses with the mixing nozzle fitment described in WO 2010/115888.

The mixing nozzle fitment presents the advantage of enabling the dispensing of concentrates that comprise pulp, seeds or particles.

Another advantage is that, depending on the choice of the slit in the valve, either foamed or flat beverages can be produced.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

### LIST OF REFERENCES IN THE DRAWINGS

mixing nozzle fitment 1
first shaft 10
   diluent inlet passage 11
   first end 111
   second end 112
second shaft 20
   curved passage 21
   first end 211
   second end 212
third shaft 30
   concentrate passage 31
   first end 32
squeezable valve 40
   dome 41
   top 411
   slit 42
   lip 43
   raised ring 44
flexible tube 50
cover 60
   fitment 61
handle 70
joint 80
flange 90
piercing fitment 100
concentrate container 110
beverage preparation machine 120
peristaltic pump 121
diluent . . . 122
diluent pump 123
diluent reservoir 124
housing 125
diluent supply line 126

1. A mixing nozzle fitment for mixing a concentrate and a diluent, for dispensing the mixture and for fitting in a beverage preparation machine comprising:
a first shaft defining a diluent inlet passage;
a second shaft defining a curved passage and attached to an end of the first shaft, and
a third shaft attached to the second shaft, the third shaft defining a concentrate passage that leads into the curved passage of the second shaft; and
a squeezable valve positioned through the third shaft, the squeezable valve being dome shaped, the top of the dome being oriented in direction of the second shaft, and the top of the dome comprising a slit.

2. The mixing nozzle fitment of claim 1, wherein the second shaft is almost perpendicular to the first shaft near its end portion opposed to the attachment with the first shaft.

3. The mixing nozzle fitment according to claim 1, wherein the third shaft is positioned relatively to the second shaft so that the longitudinal axis of the third shaft extends through the internal part of the second shaft.

4. The mixing nozzle fitment according to claim 1, wherein the top of the dome comprises a flat area.

5. The mixing nozzle fitment according to claim 1, wherein the slit presents a shape selected from the group consisting of a line, a cross and a Y.

6. The mixing nozzle fitment according to claim 1, wherein the squeezable valve is made of silicon or elastomer material.

7. The mixing nozzle fitment according to claim 1, wherein the squeezable valve is able to withstand an opening pressure comprised between 0.25 and 0.5 psi.

8. The mixing nozzle fitment according to claim 1, wherein the fitment comprises a flexible tube attached to the third shaft.

9. Package comprising a concentrate container and a mixing nozzle fitment for mixing the concentrate and a diluent, for dispensing the mixture and for fitting in a beverage preparation machine comprising a first shaft defining a diluent inlet passage, a second shaft defining a curved passage and attached to an end of the first shaft, and a third shaft attached to the second shaft, the third shaft defining a concentrate passage that leads into the curved passage of the second shaft, and a squeezable valve positioned through the third shaft, the squeezable valve being dome shaped, the top of the dome being oriented in direction of the second shaft, and the top of the dome comprising a slit, wherein the container is in fluid communication with the flexible tube of the mixing nozzle fitment.

10. Package according to claim 9, wherein the container comprises multiple portions of a beverage concentrate.

11. Package according to claim 9, wherein the concentrate comprises pulp and/or seeds.

12. A beverage preparation machine comprising:
a mixing nozzle fitment for mixing a concentrate and a diluent, for dispensing the mixture comprising a first shaft defining a diluent inlet passage, a second shaft defining a curved passage and attached to an end of the first shaft, and a third shaft attached to the second shaft, the third shaft defining a concentrate passage that leads into the curved passage of the second shaft, and a squeezable valve positioned through the third shaft, the squeezable valve being dome shaped, the top of the dome being oriented in direction of the second shaft, and the top of the dome comprising a slit positioned inside the dispensing device so that the first shaft is almost horizontal and the second shaft is almost vertical near its end portion opposed to the attachment with the first shaft;
a concentrate container attached to the third shaft of the mixing nozzle fitment by means of a flexible tube;
a diluent supply tube removably attached to the first shaft of the mixing nozzle fitment; and
a pump operatively connected to the flexible tube.

13. (canceled)
